(19) United States
(12) Patent Application Publication
(10) Pub. No.: US 2018/0348517 A1
(43) Pub. Date: Dec. 6, 2018

(54) TOP-LEANING ELECTRIC REFLECTION SHEET DEVICE

(71) Applicant: E-LEAD ELECTRONIC CO., LTD., CHANGHUA (TW)

(72) Inventor: Stephen CHEN, CHANGHUA (TW)

(21) Appl. No.: 15/612,001

(22) Filed: Jun. 2, 2017

(51) Int. Cl. G02B 27/01; B60K 35/00

(52) U.S. Cl. CPC G02B 27/0149; B60K 35/00; G02B 27/0101; B60K 2350/2056; B60K 2700/02; G02B 2027/0141; G02B 2027/0198; G02B 2027/0163; G02B 2027/0154

(57) ABSTRACT

The invention relates to a top-leaning electric reflection sheet device, which includes a base, a reflector stand, a linkage seat and an electric module, the electric module is provided to dolly move on the base to drive the linkage seat to move, and the bottom of the connecting portion of the reflector stand is synchronously driven to dolly move, and the elasticity provided for the linkage seat to move upwards could used to buffer vibration of the dashboard, so the reflection sheet could tightly lean on the windshield to improve stability of the reflection sheet and displayed images would not be shaken, to thereby enhance viewing quality.

### BACKGROUND OF THE INVENTION

### a) Field of the Invention

The invention relates to a top-leaning electric reflection sheet device and, more particularly, a reflection sheet device used in a head-up display, which is provided to let the reflection sheet tightly lean on vehicle windshield to thereby improve stability of the reflection sheet, so that displayed images would not be shaken, to thereby enhance viewing quality.

### b) Description of Prior Art

The head-up display device is from the aviation technology originally. The head-up display device may directly project messages in front of the cockpit, and pilots may conveniently obtain desired messages without lowering head to check the messages on the instrument board, pilots can easily combine the messages displayed by the head-up display with the outside scene. Since the image reflected into eyes and the central axis of the aircraft is balanced, the height of pilots may not cause error on pitch angles or visual aim. Therefore, the purpose of the head-up display is that pilots may always keep the head-up posture without lowering head to check the messages displayed on the instrument board, to reduce ignoring the rapid change in the external environment during the interval between lowering head and heading-up, and avoid the delay and discomfort due to eyes focal length is adjusted continuously.

It is one of the biggest main reasons of car accidents that drivers' line of sight is away from the front road when driving. In order to reduce the frequency and duration that drivers' line of sight away from the front road, some car manufacturers equip this kind of head-up display inside the luxury cars, thus, the drivers know the information, such as car speed and engine speed, without moving line of sight away from the front windshield, to maintain traffic safety.

In general driving condition, the shortest time of moving the line of sight away from the front road for reading the information displayed on the instrument board is 0.5 second. For the condition of highway speed of 100 km per hour, the car travels 30 meters per second, and the risk is increased when there are a lot of cars on the road. For safety, the car manufacturers may equip the head-up display in some cars to reduce the distraction of drivers, and the head-up display is used as marking practices to attract consumers.

Recently, the technique of the head-up displays used in the cars is less complicated than the head-up displays equipped in aircrafts. It is one kind of optical system, and generally it is consisted of two main equipments, which are a projector and a combiner. The projector is consisted of signal light sources, projection lens and other optical components. The signal light source of the projector is consisted of LCD monitors or CRT equipments. Light is emitted from the signal light source and projected to the combiner on the glass (or a special transparent screen) by the projector, and the combiner displays words or images. In the recent years, there are many head-up displays for installation in car in the market. These head-up displays may simply display car speed and engine speed, now display water temperature, throttle position, fuel, over-speed warning, reverse image, battery voltage, and even combine the speed radar. Some products are stressed as quick installation, which are just connected to the car PC without using other cables. In the luxury cars of some car manufacturers, the information of the navigation system, front and rear vehicle distance is added into the information displayed by the head-up display, which is increased a lot of convenience for drivers. Besides, the external head-up displays in the market is various, and the prices are from several hundred dollars for simple function ones, to ten thousand dollars for good quality and versatile ones.

As shown in FIG. 1, which is a structure diagram of embodiment of patent with number TW M530409 (in the following called the cited reference), wherein the reflection sheet device 5 is consisted of a base 51, a shaft group 52 and a reflection sheet 53, the angle adjustment module of the shaft group 52 is provided to easily adjust horizontal and flip angle of the reflection sheet 53 and to let the top of the reflection sheet 53 stably lean against the windshield W1 of a vehicle, to thereby reduce shakes and let a driver obtain the best visual angle, to thereby improve driving safety. Although the cited reference has already disclosed the top-leaning structure of the reflection sheet 53, a shaft mechanism is mainly used to move and adjust the rotation angle of the reflection sheet 53. In order to prevent the reflection sheet 53 from being shaken, a buffer block 532 is set on the top end 531 of the reflection sheet 53 and a blade 54 is set on the windshield W1. Since the reflection sheet 53 of the cited reference could not tightly lean against the windshield W1, shakes may easily be occurred and the viewing quality of displayed images may be affected.

### SUMMARY OF THE INVENTION

In view of drawbacks of the prior art, the inventor finally completes top-keaning electric reflection sheet device of the present invention after numerous improvements, namely, the object of the present invention is to provide a top-leaning electric reflection sheet device for reducing shaking of the reflection sheet, to thereby enhance viewing quality of displayed images.

To achieve the above object according to the invention, the top-leaning electric reflection sheet device of the present invention, including:

a base;

a reflector stand, which includes a reflection sheet and a connecting portion, the connecting portion is connected to the reflection sheet;

a linkage seat, which includes a first shaft group and a second shaft group, a first torsion spring is set on the first shaft group, the first shaft group is pivoted on the connecting portion, a second torsion spring is set on the second shaft group, the first torsion spring and the second torsion spring are used to provide elasticity for the linkage seat to move upwards;

an electric module, which is pivoted the second shaft group, the electric module is provided to dolly move on the base to drive the linkage seat to move, and the bottom of the connecting portion is synchronously driven to dolly move.

The above electric module, a circuit board, a motor set and a gear set are set on it, the motor set is electrically connected to the circuit board, the reflector stand is driven by the gear set linked to the motor set for being closed or opened, and the rotation angle of the reflection sheet is provided to be adjusted.

The above base, two slide rails are respectively set on its two sides, a curved section is set on each slide rail, two guide components are respectively set on two sides of the electric module, the guide components are engaged with the slide rails.

The above base, a first lateral plate and a second lateral plate are respectively set on its two sides, two oblique walls are respectively set on the front side of the first lateral plate and the second lateral plate.

The above linkage seat, further includes a seat body, the first shaft group is set on the front side of the seat body, the second shaft group is set on the rear side of the seat body, a stopper is set on a side of the seat body, a guide arm is set on the bottom side of the seat body.

The base, a rack and pinion is set on its one side, a curved section is set on the rack and pinion, the electric module includes a gear set, the gear set is engaged between the rack and pinion and the connecting portion.

The above connecting portion includes a curved groove, the electric module includes a gear ser, the gear set includes a first gear, a second gear, a third gear, a fourth gear and a guide column, the guide column is set on a side of the first gear, the guide column is inserted into the curved groove, a rack and pinion is set on the first lateral plate of the base, the second gear and the fourth gear are coaxial and driven to rotate by the motor set, the second gear is engaged with the rack and pinion, the first gear is engaged with the third gear, the fourth gear is engaged with the third gear, the guide column is linked with the first gear, the guide column is provided to move along the curved groove to thereby limit the elasticity of the first torsion spring.

The above electric module, further includes a micro switch, the micro switch is set on the base, the micro switch is electrically connected to the electric module,

The above electric module further includes a button set, the button set is electrically connected to the electric module.

The above reflection sheet, a damping block is set on its top end for reducing shaking of the reflection sheet.

### BRIEF DESCRIPTION OF THE DRAWINGS

FIG. 1 is a schematic diagram of conventional structure;

FIG. 2 is a three-dimensional exploded schematic diagram of the present invention;

FIG. 3 is a three-dimensional schematic diagram of the first lateral plate of the present invention;

FIG. 4 is a schematic diagram of appearance of the present invention;

FIG. 5 is a schematic diagram of the reflection sheet being closed of the present invention;

FIG. 6 is a schematic diagram (1) of operation of the reflection sheet being opened of the present invention;

FIG. 7 is a schematic diagram (2) of operation of the reflection sheet being opened of the present invention;

FIG. 8 is a schematic diagram (3) of operation of the reflection sheet being opened of the present invention;

FIG. 9 is a schematic diagram of adjusting the angle of the reflection sheet of the present invention.

FIG. 10 is a schematic diagram of the reflection sheet top leaning on the windshield of the present invention; and

FIG. 11 is a schematic diagram of another embodiment of the present invention.

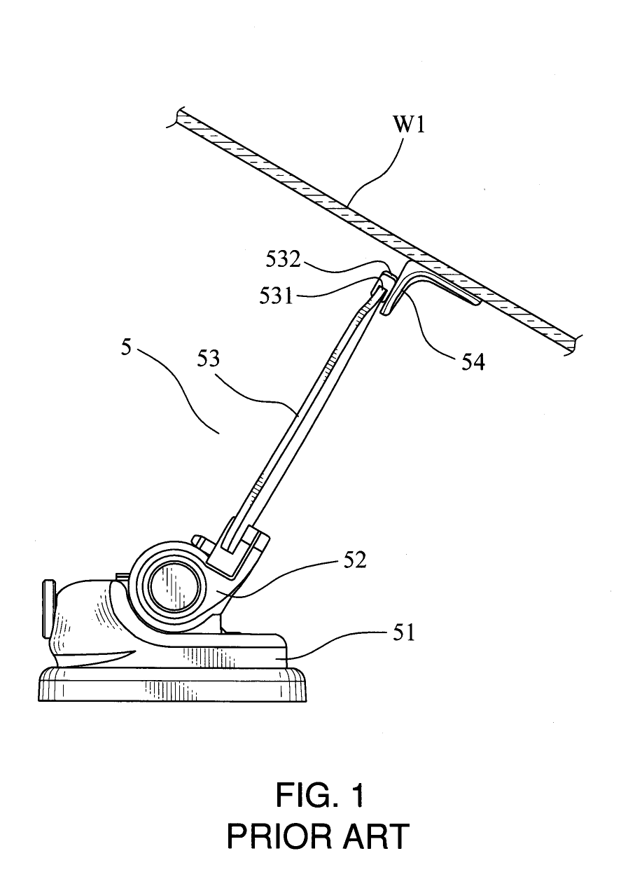

### DETAILED DESCRIPTION OF THE INVENTION

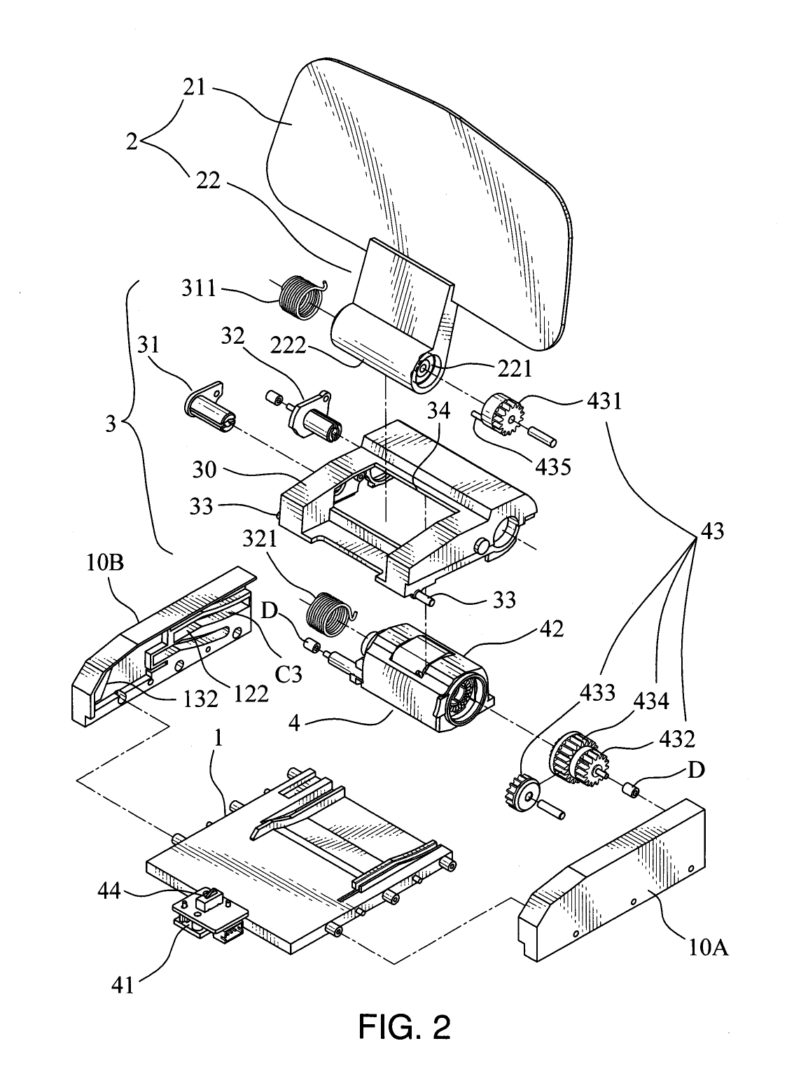

As shown in FIG. 2 to FIG. 5, which is the embodiment of the top-leaning electric reflection sheet device of the present invention, including:

a base 1, a first lateral plate 10A and a second lateral plate 10B are respectively set on its two sides;

a reflector stand 2, which includes a reflection sheet 21 and a connecting portion 22, the connecting portion 22 is connected to the reflection sheet 21;

a linkage seat 3, which includes a seat body 30, a first shaft group 31 and a second shaft group 32, a first torsion spring 311 is set on the first shaft group 31, the first shaft group 31 is set on the front side of the seat body 30 and is pivoted on the connecting portion 22, a second torsion spring 321 is set on the second shaft group 32, the second shaft group 32 is set on the rear side of the seat body 30, the first torsion spring 311 and the second torsion spring 321 are used to provide elasticity for the linkage seat 3 to move upwards;

an electric module 4, the first lateral plate 10A and the second lateral plate 10B are engaged with its two sides, the second shaft group 32 is pivoted the electric module 4, the electric module 4 is provided to dolly move on the base 1 to drive the linkage seat 3 to move and the bottom 222 of the connecting portion 22 is synchronously driven to dolly move.

The above electric module 4, a circuit board 41, a motor set 42 and a gear set 43 are set on it, the motor set 42 is electrically connected to the circuit board 41, the reflector stand 2 is driven by the gear set 43 linked to the motor set 42 for being closed or opened, and the rotation angle of the reflection sheet 21 is provided to be adjusted.

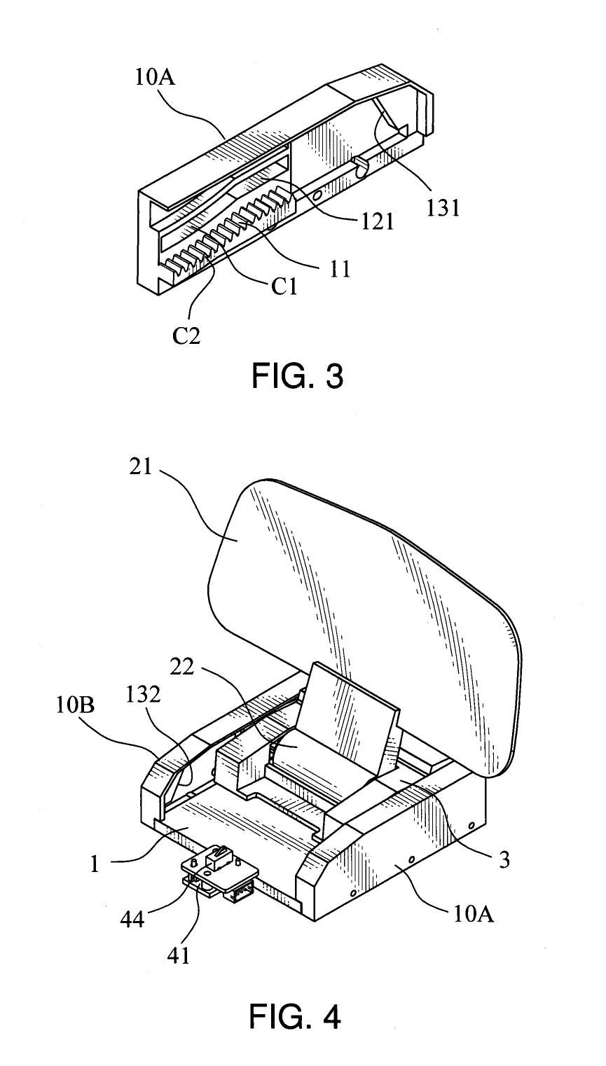

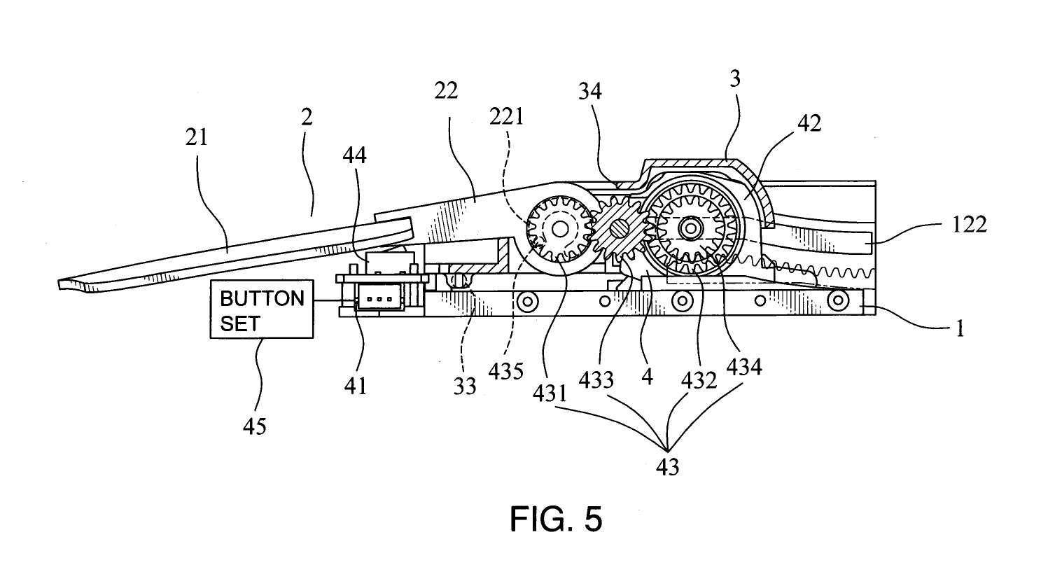

As shown in FIG. 2 and FIG. 5, the above connecting portion 22 includes a curved groove 221, the above gear set 43 includes a first gear 431, a second gear 432, a third gear 433, a fourth gear 434 and a guide column 435, the guide column 435 is set on a side of the first gear 431, the guide column 435 is inserted into the curved groove 221, a rack and pinion 11 is set on the first lateral plate 10A of the base 1 (please refer to FIG. 3), the second gear 432 and the fourth gear 434 are coaxial and driven to rotate by the motor set 42, the second gear 432 is engaged with the rack and pinion 11, the first gear 431 is engaged with the third gear 433, the fourth gear 434 is engaged with the third gear 433, the guide column 435 is linked with the first gear 431, the guide column 435 is provided to move along the curved groove 221 to thereby limit the elasticity of the first torsion spring 311.

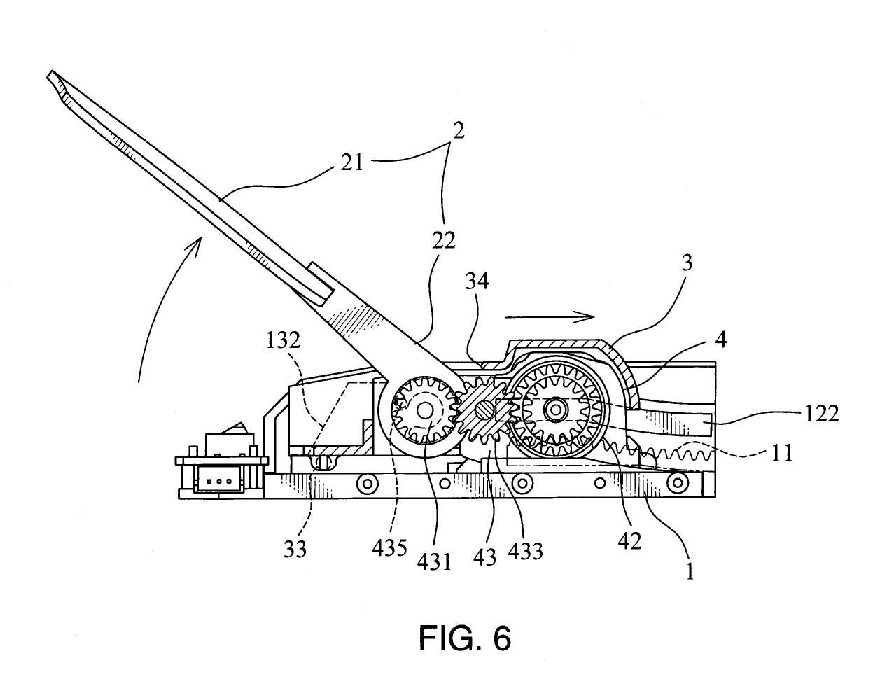

As shown in FIG. 2, FIG. 3, FIG. 5, FIG. 6, the first lateral plate 10A and the second lateral plate 10B are corresponded to each other and two slide rails 121, 122 are respectively set on them; two guide components D are respectively set on two sides of the electric module 4, the guide components D are engaged with the slide rails 121, 122, the gear set 43 is engaged between the rack and pinion 11 and the connecting portion 22. When the electric module 4 moves backwards, the reflection sheet 21 is driven to be flipped up, the linkage seat 3 is driven to slide backwards by the gear set 43 through engagement with the rack and pinion 11 and guidance of the slide rails 121, 122.

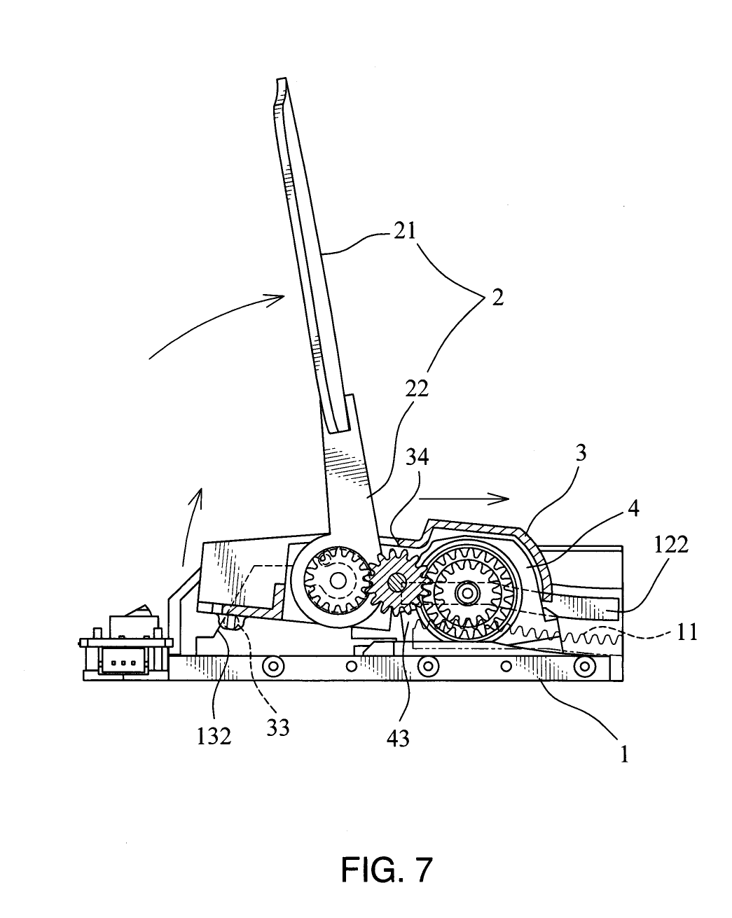

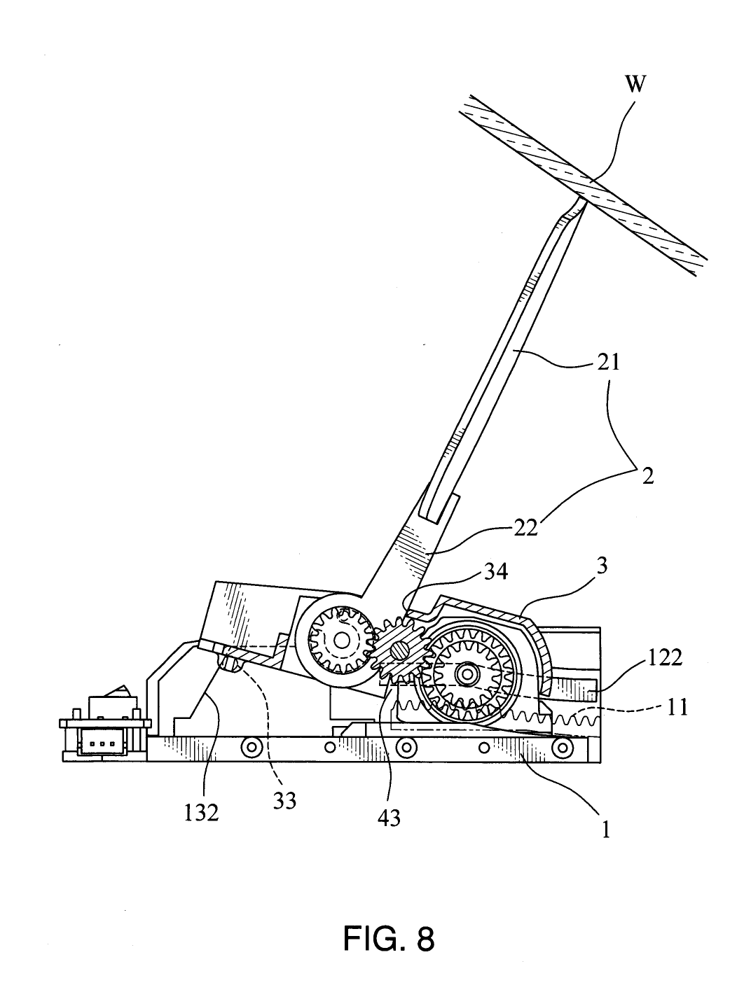

As shown in FIG. 2, FIG. 3, FIG. 6, FIG. 7, two oblique walls 131, 132 are respectively set on the front side of the first lateral plate 10A and the second lateral plate 10B of the base 1. When the electric module 4 moves backwards, the linkage seat 3 is flipped up by the elasticity provided from the second torsion spring 321. Two guide arms 33 are set protruded on two sides of the bottom of the seat body 30 respectively, the guide arms 33 are provided to guide the linkage seat 3 to be flipped up along the oblique walls 131, 132 (as shown in FIG. 8).

As shown in FIG. 2, FIG. 8, a stopper 34 is set on a side of the seat body 30, the connecting portion 22 is limited to stop without flipping backwards when it touches the stopper 34 of the seat body 30.

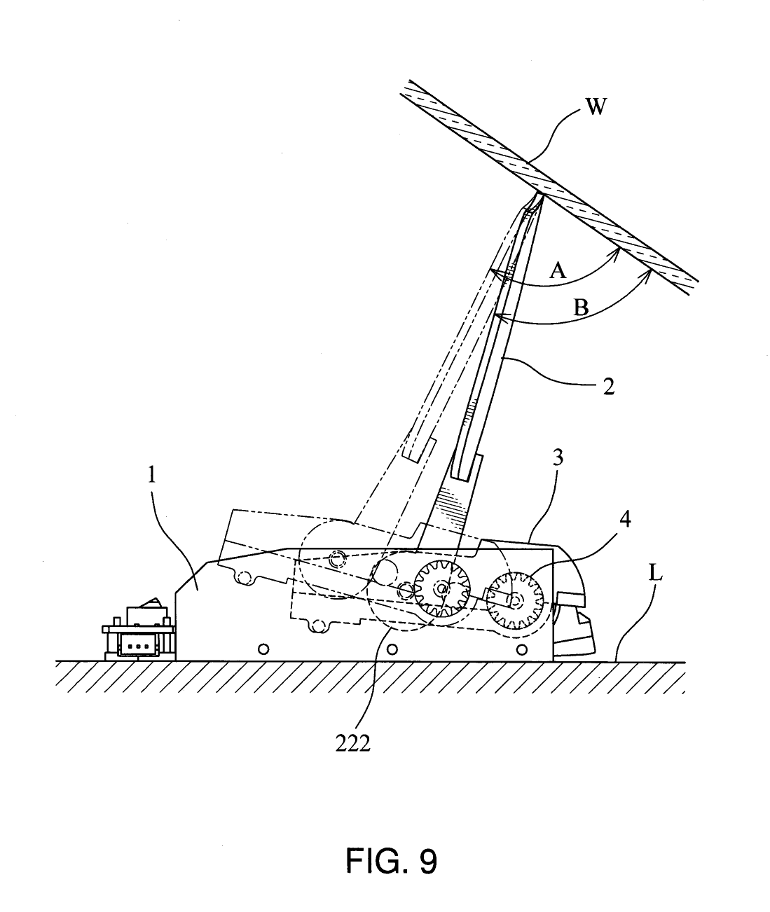

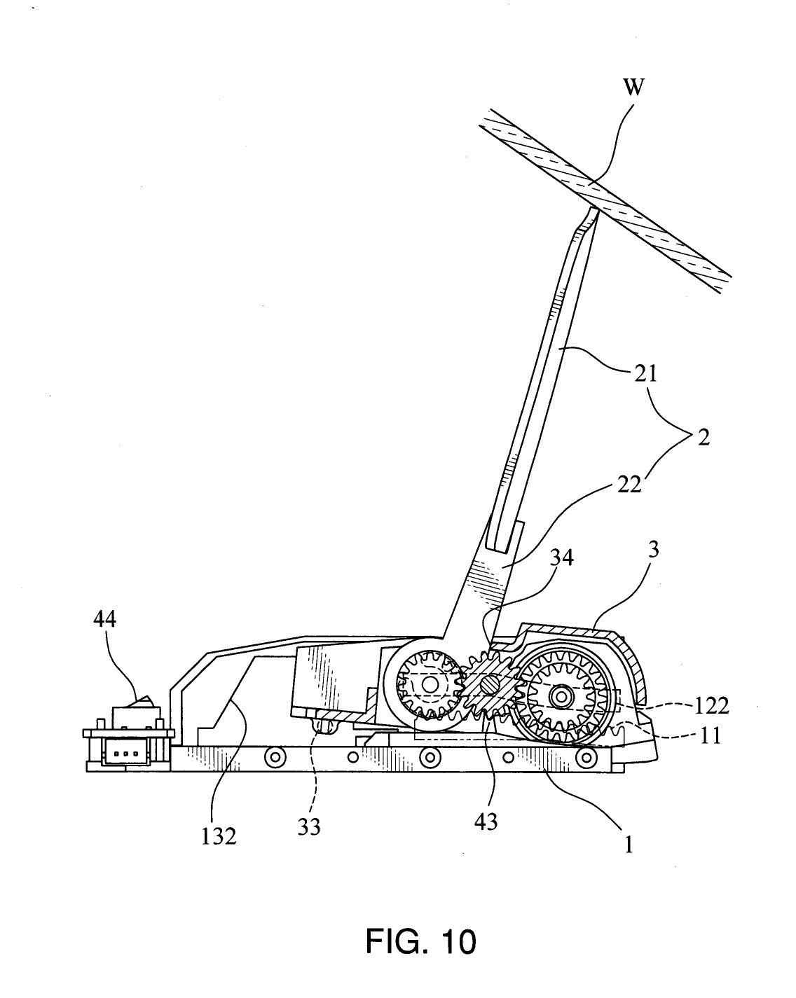

As shown in FIG. 2, FIG. 3, two curved sections C1, C2 are respectively set on the moving path of the rack and pinion 11 and the slide rail 121 of the lateral plate 10A, similarly, a curved section C3 is set on the slide rail 122 of the second lateral plate 10B corresponded to the lateral plate 10A. The curved sections C1, C2, C3 is set to provide for the reflection sheet 21 to rotate and slide with a windshield W served as the fulcrum when it touches the windshield W (shown as FIG. 8, FIG. 9, FIG. 10); namely, when the gear set 43 continues rotating, the guide column 435 has already moved to escape the position for pushing the reflection sheet 21, at this time, the linkage seat 3 could continue rotating to the position of the curved sections C1, C2, C3 without being limited, so that the reflection sheet 21 could tightly lean against the windshield W to improve stability of the reflection sheet 21 and displayed images would not be shaken.

As shown in FIG. 5, the electric module 4 further includes a micro switch 44, the micro switch 44 is set on the base 1 and located on a position that the reflector stand 2 could touch when it is close, the micro switch 44 is electrically connected to the circuit board 42 of the electric module 4, the micro switch 44 is provided to stop the motor set 42 when detecting that the reflector stand 2 is close.

The above electric module 4, further includes a button set 45, the button set 45 is electrically connected to the electric module 4, the button set is provided to control the motion of the electric module 4 for being opened ON or being close OFF, adjust the motor set 42 to slide forward or backward and drive the linkage seat 3 to adjust the rotation angle of the reflection sheet 21. Namely, the reflector stand 2 may be folded up when a user operate the button set for being close OFF, the reflector stand 2 may be opened to the previous flip angle.

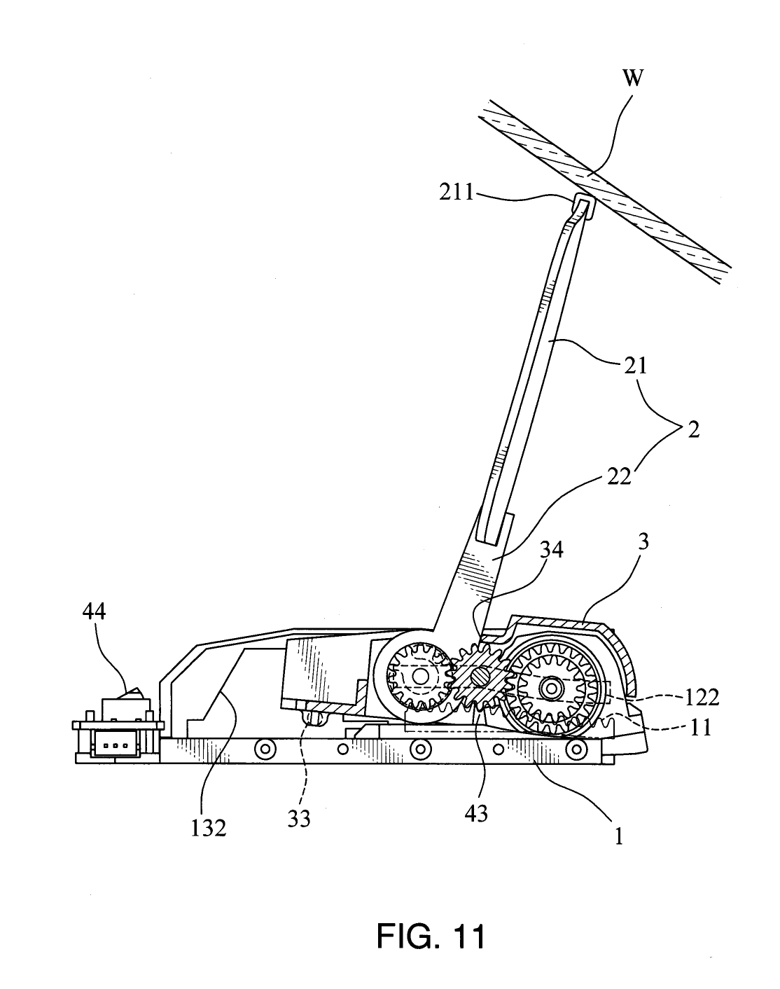

As shown in FIG. 11, a damping block 211 is set on the top end of the reflection sheet 21 of the present invention, the damping block 211 is provided to reduce shaking of the reflection sheet 21.

Please refer to FIG. 2, FIG. 3 and FIG. 6 to FIG. 10, by composition of the above components, the top-leaning electric reflection sheet device of the present invention is used to install on a dashboard L. When a user operate the button set for being opened ON, the gear set 43 driven by the motor set 42 of the electric module 4 drives the reflector stand 2 being opened; when the electric module 4 moves backwards, the linkage seat 3 is driven to slide backwards by the gear set 43 through engagement with the rack and pinion 11 and guidance of the slide rails 121, 122, the second torsion spring 321 is used to provide elasticity for the linkage seat 3 to be flipped up, and the guide arms 33 guide the linkage seat 3 to be flipped up along the oblique walls 131, 132 simultaneously, the rack and pinion 11 and the curved sections C1, C2 of the first lateral plate 10A, and the curved section C3 of the slide rail 122 of the lateral plate 10B are used to provide for the reflection sheet 21 to rotate and slide with the windshield W served as the fulcrum when it touches the windshield W; namely, when the gear set 43 continues rotating, the guide column 435 has already moved to escape the position for pushing the reflection sheet 21, at this time, the linkage seat 3 could continue rotating to the position of the curved sections C1, C2, C3 without being limited, so that the reflection sheet 21 could tightly lean against the windshield W, the first torsion spring 311 and the second torsion spring 321 simultaneously provide elasticity for the linkage seat 3 to move upwards to reduce the leaning angle for the windshield W (as shown in FIG. 9); with the linkage seat 3 moving forward, a first angle that only the reflection sheet 21 leaning becomes to a second angle B with a smaller angle; since the stability of leaning is greater if the angle is smaller, there is no need to install any stopper on the windshield W; the elasticity provided for the linkage seat 3 to move upwards could used to buffer vibration of the dashboard L, so the reflection sheet 21 could tightly lean on the windshield W to generate stable displayed images without shaking. Besides, the electric module 4 is provided to dolly move on the base to drive the linkage seat 3 to move, the bottom 222 of the connecting portion 22 would dolly move correspondingly, so that the displayed angle of the reflection sheet 21 could be adjusted under the condition that the reflection sheet 21 leaning against the windshield W without moving and produce friction.

As shown in FIG. 2, FIG. 5, in the present invention, when a user wants to close the reflection sheet 21, he should only operate the button set 45 for being close OFF, the motor set 42 of the electric module 4 would reversely drive the gear set 43 to drive the reflector stand 2 to be folded up, the motor set 42 would be stopped when the reflection sheet 21 touches the micro switch 44, and the reflection sheet 21 is finally folded up.

What is claimed is:

1. A top-leaning electric reflection sheet device, which includes:
a base;
a reflector stand, which includes a reflection sheet and a connecting portion, the connecting portion is connected to the reflection sheet;
a linkage seat, which includes a first shaft group and a second shaft group, a first torsion spring is set on the first shaft group, the first shaft group is pivoted on the connecting portion, a second torsion spring is set on the second shaft group, the first torsion spring and the second torsion spring are used to provide elasticity for the linkage seat to move upwards;
an electric module, which is pivoted the second shaft group, the electric module is provided to dolly move on the base to drive the linkage seat to move, and the bottom of the connecting portion is synchronously driven to dolly move.

2. The top-leaning electric reflection sheet device as claimed in claim 1, wherein a circuit board, a motor set and a gear set are set on the electric module, the motor set is electrically connected to the circuit board, the reflector stand is driven by the gear set linked to the motor set for being closed or opened, and the rotation angle of the reflection sheet is provided to be adjusted.

3. The top-leaning electric reflection sheet device as claimed in claim 1, wherein two slide rails are respectively set on two sides of the base, a curved section is set on each slide rail, two guide components are respectively set on two sides of the electric module, the guide components are engaged with the slide rails.

4. The top-leaning electric reflection sheet device as claimed in claim 1, wherein a first lateral plate and a second lateral plate are respectively set on two sides of the base, two oblique walls are respectively set on the front side of the first lateral plate and the second lateral plate.

5. The top-leaning electric reflection sheet device as claimed in claim 1, wherein the linkage seat further includes a seat body, the first shaft group is set on the front side of the seat body, the second shaft group is set on the rear side of the seat body, a stopper is set on a side of the seat body, a guide arm is set on the bottom side of the seat body.

6. The top-leaning electric reflection sheet device as claimed in claim 1, wherein a rack and pinion is set on one side of the base, a curved section is set on the rack and pinion, the electric module includes a gear set, the gear set is engaged between the rack and pinion and the connecting portion.

7. The top-leaning electric reflection sheet device as claimed in claim 1, wherein the above connecting portion includes a curved groove, the electric module includes a gear ser, the gear set includes a first gear, a second gear, a third gear, a fourth gear and a guide column, the guide column is set on a side of the first gear, the guide column is inserted into the curved groove, a rack and pinion is set on the first lateral plate of the base, the second gear and the fourth gear are coaxial and driven to rotate by the motor set, the second gear is engaged with the rack and pinion, the first gear is engaged with the third gear, the fourth gear is engaged with the third gear, the guide column is linked with the first gear, the guide column is provided to move along the curved groove to thereby limit the elasticity of the first torsion spring.

8. The top-leaning electric reflection sheet device as claimed in claim 1, wherein the electric module further includes a micro switch, the micro switch is set on the base, the micro switch is electrically connected to the electric module.

9. The top-leaning electric reflection sheet device as claimed in claim 1, wherein the electric module further includes a button set, the button set is electrically connected to the electric module.

10. The top-leaning electric reflection sheet device as claimed in claim 1, wherein a damping block is set on the top end of the reflection sheet for reducing shaking of the reflection sheet.
